(19) United States
(12) Patent Application Publication
(10) Pub. No.: US 2026/0221865 A1
(43) Pub. Date: Jul. 30, 2026

(54) HYBRID RECTIFIER FOR DRIVING DYNAMICALLY VARYING DIRECT CURRENT LOAD

(71) Applicant: Caterpillar Inc., Peoria, IL (US)

(72) Inventor: Jyothiraditya RAMASWAMY, Anupuram (IN)

(21) Appl. No.: 19/145,038

(22) PCT Filed: Dec. 13, 2023
(86) PCT No.: PCT/US2023/083718

§ 371 Date: Jul. 1, 2025

(30) Foreign Application Priority Data
Jan. 4, 2023 (IN) 202311000665

(51) Int. Cl. H02M 1/00; H02M 7/217

(52) U.S. Cl. CPC H02M 1/0095; H02M 1/0019; H02M 1/0025; H02M 1/0043; H02M 1/0077; H02M 7/217

(57) ABSTRACT

A hybrid rectifier for driving a dynamically varying direct current (DC) load (V_{dc}). The hybrid rectifier includes a first unit having at least two transformers are configured to receive a three-phase input of alternating current (AC), and provide at least two AC outputs (I₁, I₂, . . . I_{N}) to at least two passive rectifiers (R_{P1}, R_{P2}, . . . R_{PN}). The voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ). The hybrid rectifier includes a second unit having a transformer (T_{A}) configured to receive the three-phase AC input and provide an AC output (I_{A}) having a voltage (V_{AO}) to an active rectifier (R_{A}). The hybrid rectifier further includes a control system coupled to the active rectifier (R_{A}). The control system is configured to vary a control voltage (V_{ARC}) of DC output by the active rectifier (R_{A}) to facilitate a matching of a total voltage (V_{T}) across the dynamically varying DC load (V_{dc}) with a desired target DC reference value (V_{ref}).

### TECHNICAL FIELD

The present disclosure relates to a hybrid rectifier. More particularly, the present disclosure relates to a hybrid rectifier for driving a dynamically varying direct current load.

### BACKGROUND

Rectifiers are used in a variety of AC/DC power transmission line networks, double conversion uninterruptible power supply (UPS), chargers, and various other electronic circuits to convert an electrical supply in an alternating current (AC) form to a direct current (DC) form. There are various types of rectifiers, including passive rectifiers and active rectifiers. Passive rectifiers employ passive components like diodes whereas active rectifiers utilize active components like insulated-gate bipolar transistors (IGBTs), to control the flow of current. Each of these rectifiers offers different levels of performance characteristics. The active components may include controllable switches, and may be generally less reliable than the passive components. Also, the use of active components increases the cost of active rectifiers. However, the active rectifiers provide better voltage regulation as compared to the passive rectifiers due to the utilization of the active components.

U.S. Pat. No. 11,183,946 (hereinafter “the '946 reference”) relates to an integrated rectifier-generator AC-DC conversion circuit and system. Although the '946 reference discloses a combination of passive and active rectifiers, the '946 reference merely provides a means for controlling electrical power at a power generation side of an electrical grid typically comprising at least one electrical power generator, for e.g., one or more Permanent Magnet Synchronous Generators (PMSGs). However, the electrical grid may also comprise a power distribution side located downstream of the power generation side. This power distribution side may include, inter alia, power transmission and power distribution grids respectively that are sequentially connected to drive one or more loads, for example, electrically operated mining trucks. The combination of passive and active rectifiers disclosed by the '946 reference can only be applied to an electrical power generation side of an electrical grid and not to an electrical distribution side of the electrical grid as the '946 reference specifically relates to a mechanical-to-electrical energy conversion system. However, working conditions and challenges faced by electrical-to-electrical conversion systems greatly differ from that encountered by mechanical-to-electrical energy conversion systems. Hence, there exists a need for an electrical-to-electrical conversion system to control the electrical power on the distribution side of the electrical grid while effectively meeting a rapidly changing load demand.

### SUMMARY

In an aspect, the present disclosure relates to a hybrid rectifier for driving a dynamically varying direct current (DC) load (V_{dc}). The hybrid rectifier includes a first unit having at least two transformers (T₁, T₂, . . . T_{N}) and at least two passive rectifiers (R_{P1}, R_{P2}, . . . R_{PN}) corresponding to, and connected in series with, the at least two transformers (T₁, T₂, . . . T_{N}). The transformers (T₁, T₂, . . . T_{N}) are configured to receive a three-phase input of alternating current (AC) from an AC source having a supply voltage (V₁), and operably provide AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ) equal to 60±5/N, where N corresponds to a number of AC outputs (I₁, I₂, . . . I_{N}) provided by the transformers (T₁, T₂, . . . T_{N}), and a maximum difference between phases of the transformers (T₁, T₂, . . . T_{N}) lies within a range of 60±5 degrees. The passive rectifiers (R_{P1}, R_{P2}, . . . R_{PN}) are configured to receive corresponding ones of the phase shifted AC outputs (I₁, I₂, . . . I_{N}) from the transformers (T₁, T₂, . . . T_{N}) as input and provide corresponding DC outputs having voltages (V_{PR1}, V_{PR2} . . . V_{PRN}). The hybrid rectifier further includes a second unit arranged in parallel to the first unit on an input side corresponding to the AC source. The second unit has a transformer (T_{A}) configured to receive the three-phase AC input having the supply voltage (V₁) and provide an AC output (I_{A}) having a voltage (V_{AO}) and an active rectifier (R_{A}) connected in series with the transformer (T_{A}) to receive the AC output (I_{A}) from the transformer (T_{A}) as input and provide a DC output having a dynamically varying control voltage (V_{ARC}). The hybrid rectifier further includes a control system coupled to the active rectifier (R_{A}) of the second unit. The control system is configured to receive a desired target DC reference value (V_{ref}) from a user as input and measure a total voltage (V_{T}=V_{PR1}+V_{PR2}+ . . . V_{PRN}+V_{ARC}), from the DC outputs of the first and second units, across the dynamically varying DC load (V_{dc}). The control system is further configured to determine an error (E) between the total voltage (V_{T}) across the dynamically varying DC load (V_{dc}) and the desired target DC reference value (V_{ref}) input by the user and based on the determined error (E), vary the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load.

In another aspect, the present disclosure is directed to a method of making a hybrid rectifier for driving a dynamically varying direct current (DC) load (V_{dc}). The method includes providing a first unit having at least two transformers (T₁, T₂, . . . T_{N}) and at least two passive rectifiers (R_{P1}, R_{P2}, . . . R_{PN}) corresponding to, and connected in series with, the at least two transformers (T₁, T₂, . . . T_{N}). The transformers (T₁, T₂, . . . T_{N}) are configured to receive a three-phase input of alternating current (AC) from an AC source having a supply voltage (V₁), and operably provide AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ) equal to 60±5/N, where N corresponds to a number of AC outputs (I₁, I₂, . . . I_{N}) provided by the transformers (T₁, T₂, . . . T_{N}), and a maximum difference between phases of the transformers (T₁, T₂, . . . T_{N}) lies within a range of 60±5 degrees. The passive rectifiers (R_{P1}, R_{P2}, . . . R_{PN}) are configured to receive corresponding ones of the phase shifted AC outputs (I₁, I₂, . . . I_{N}) from the transformers (T₁, T₂, . . . T_{N}) as input and provide corresponding DC outputs having voltages (V_{PR1}, V_{PR2} . . . V_{PRN}). The method further includes providing a second unit arranged in parallel to the first unit on an input side corresponding to the AC source. The second unit has a transformer (T_{A}) configured to receive the three-phase AC input having the supply voltage (V₁) and provide an AC output (I_{A}) having a voltage (V_{AO}) and an active rectifier (R_{A}) connected in series with the transformer (T_{A}) to receive the AC output (I_{A}) from the transformer (T_{A}) as input and provide a DC output having a dynamically varying control voltage (V_{ARC}). The method further includes coupling a control system to the active rectifier (R_{A}) of the second unit. The control system is configured to receive a desired target DC reference value (V_{ref}) from a user as input and measure a total voltage (V_{T}=V_{PR1}+V_{PR2}+ . . . V_{PRN}+V_{ARC}), from the DC outputs of the first and second units, across the dynamically varying DC load (V_{dc}). The control system is further configured to determine an error (E) between the total voltage (V_{T}) across the dynamically varying DC load (V_{dc}) and the desired target DC reference value (V_{ref}) input by the user and based on the determined error (E), vary the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load.

In yet another aspect, the present disclosure relates to a method of operating a hybrid rectifier for driving a dynamically varying direct current (DC) load (V_{dc}). The hybrid rectifier includes first and second units parallelly connected on an input side to receive a three-phase input of alternating current (AC) from an AC source having a first voltage (V₁). The method includes receiving, by at least two transformers (T₁, T₂, . . . T_{N}) in the first unit, the three-phase input of alternating current (AC) from the AC source having the first voltage (V₁) and operably providing, by the transformers (T₁, T₂, . . . T_{N}), at least two AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the first voltage (V₁) successively by a predetermined angle (θ) equal to 60±5/N, where N corresponds to a number of AC outputs (I₁, I₂, . . . I_{N}) provided by the transformers (T₁, T₂, . . . T_{N}), and a maximum difference between phases of the transformers (T₁, T₂, . . . T_{N}) lies within a range of 60±5 degrees. The method further includes receiving, by at least two passive rectifiers (R_{P1}, R_{P2}, . . . R_{PN}) in the first unit corresponding to, and connected in series with the transformers (T₁, T₂, . . . T_{N}), corresponding ones of the phase shifted AC outputs (I₁, I₂, . . . I_{N}) from the transformers (T₁, T₂, . . . T_{N}) as input and providing, by the passive rectifiers (R_{P1}, R_{P2}, . . . R_{PN}), corresponding DC outputs having voltages (V_{PR1}, V_{PR2} . . . V_{PRN}). The method further includes receiving, by a transformer (T_{A}) in the second unit, the three-phase AC input having the first voltage (V₁) and providing, by the transformer (T_{A}), an AC output (I_{A}) having a voltage (V_{AO}). The method further includes receiving, by an active rectifier (R_{A}) connected in series with the transformer (T_{A}), the AC output (I_{A}) from the transformer (T_{A}) as input and providing, by the active rectifier (R_{A}), a DC output having a dynamically varying control voltage (V_{ARC}). Further, the method includes receiving, by a control system coupled to the active rectifier (R_{A}) of the second unit, a desired target DC reference value (V_{ref}) from a user as input and measuring, by the control system, a total voltage (V_{T}=V_{PR1}+V_{PR2}+ . . . V_{PRN}+V_{ARC}), from the DC outputs of the first and second units, across the dynamically varying DC load (V_{dc}). The method further includes determining, by the control system, an error (E) between the total voltage (V_{T}) across the dynamically varying DC load (V_{dc}) and the desired target DC reference value (V_{ref}) input by the user and based on the determined error (E), varying, by the control system, the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load where varying the control voltage (V_{ARC}) of the DC output by the active rectifier (R_{A}) includes receiving, by a Proportional-Integral (PI) controller (PI₁) of the control system, the determined error (E) to adjust a park-transformed direct component of current (I_{d}) input to the active rectifier (R_{A}) by the transformer (T_{A}) of the second unit and generating, by the PI controller of the control system, a control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit until the total voltage (V_{T}) across the dynamically varying DC load (V_{dc}) is equal to the desired target DC reference value (V_{ref}). The control voltage (V_{ARC}) of the DC output is varied by the active rectifier (R_{A}) if a voltage of the three-phase input of alternating current (AC) from the AC source deviates from the first voltage (V₁) rated for the given AC source.

### BRIEF DESCRIPTION

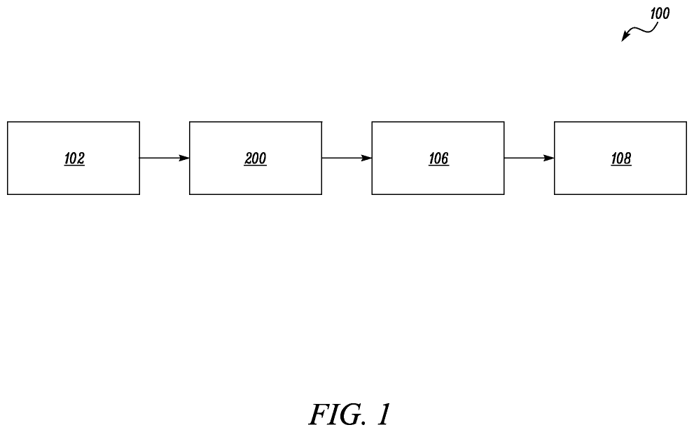

FIG. 1 is a charger system employing a hybrid rectifier, in accordance with an embodiment of the present disclosure;

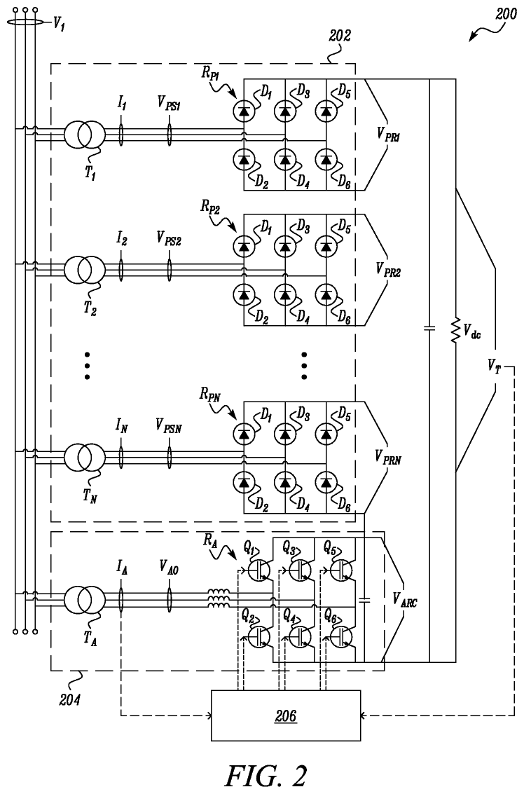

FIG. 2 is a circuit diagram of the hybrid rectifier, in accordance with an embodiment of the present disclosure;

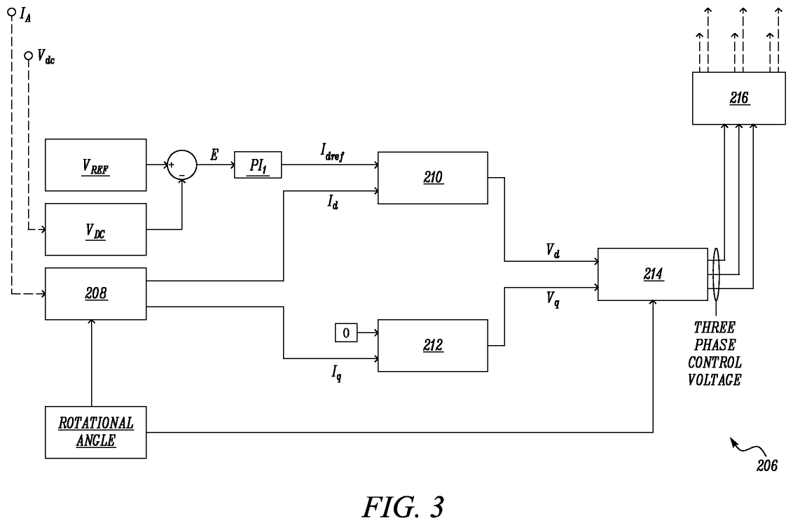

FIG. 3 is a circuit diagram of a control system coupled to an active rectifier of the hybrid rectifier, in accordance with an embodiment of the present disclosure;

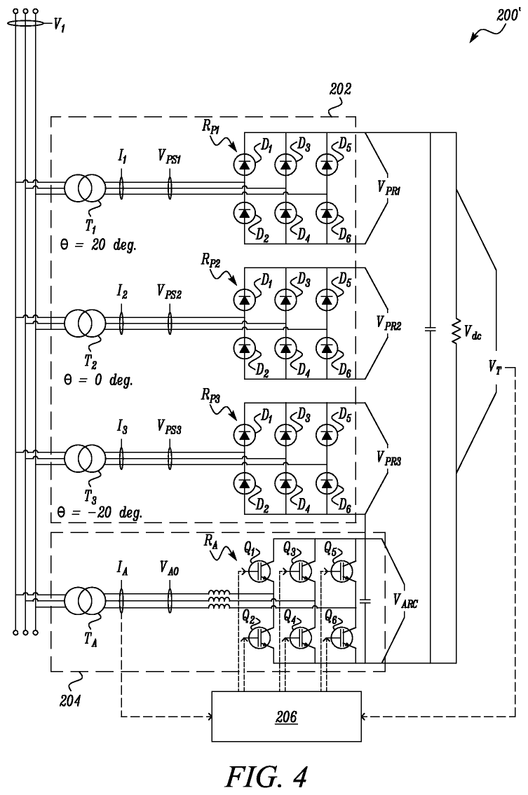

FIG. 4 is an exemplary circuit diagram of the hybrid rectifier with three (3) passive rectifiers, in accordance with an embodiment of the present disclosure;

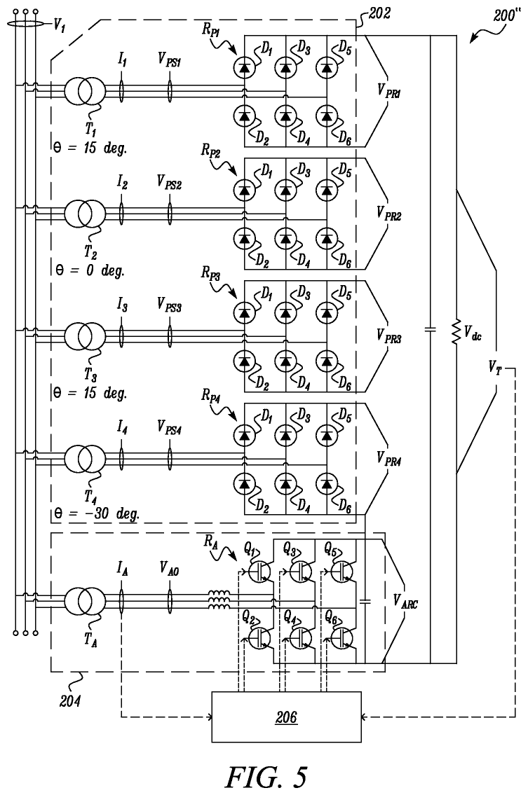

FIG. 5 is an exemplary circuit diagram of the hybrid rectifier with four (4) passive rectifiers, in accordance with an embodiment of the present disclosure;

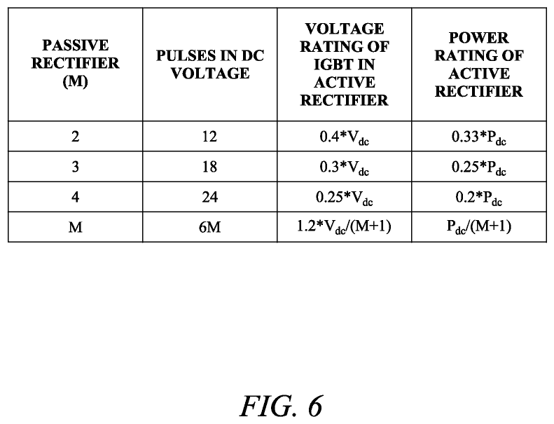

FIG. 6 is a tabulation of mathematical correlations drawn between number of passive rectifiers and corresponding operational characteristics of the hybrid rectifier, in accordance with an embodiment of the present disclosure;

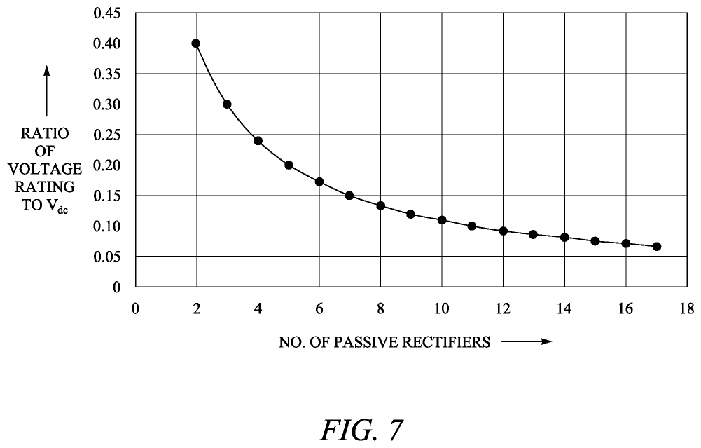

FIG. 7 is a graphical representation of voltage rating of fully controllable semiconductor device in the active rectifier to the maximum output DC voltage with a change in number of passive rectifiers of the hybrid rectifier, in accordance with an embodiment of the present disclosure;

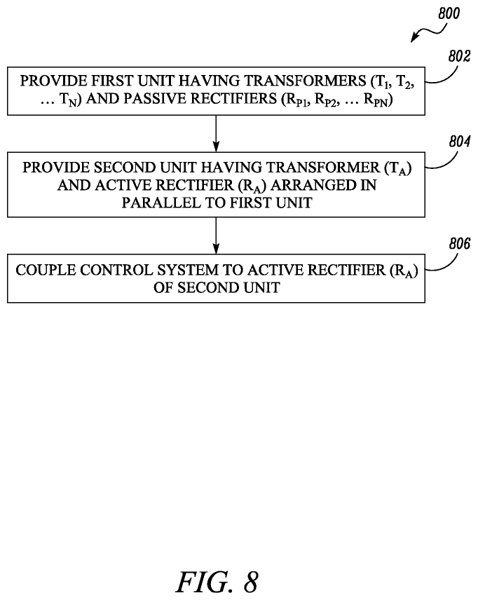

FIG. 8 is a method of making the hybrid rectifier, in accordance with an embodiment of the present disclosure; and

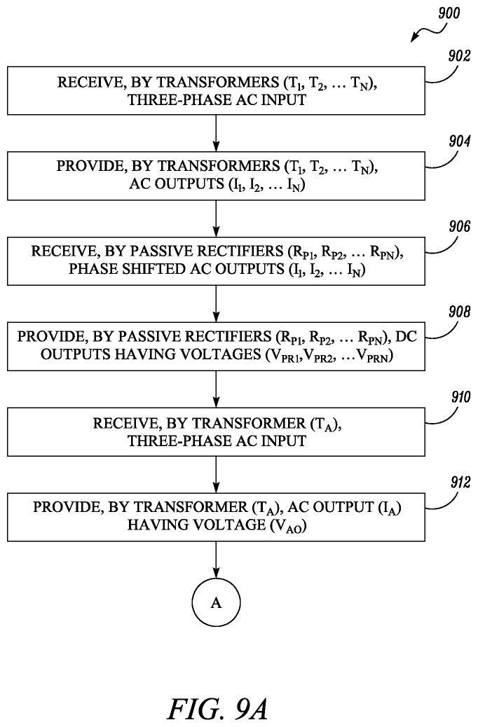

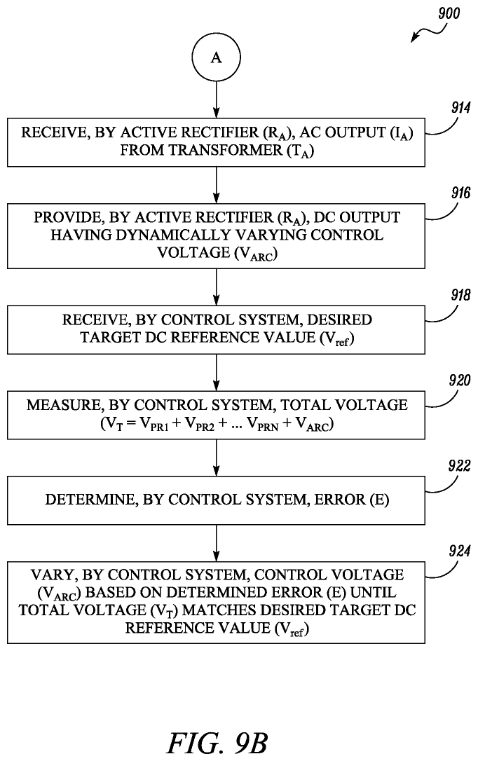

FIGS. 9A-9B is a method of operating the hybrid rectifier, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

Referring to FIG. 1, an exemplary charger system 100 employing a hybrid rectifier 200 is shown. The charger system 100 is utilized to store energy in an energy storage device 108, such as, a battery, such that the battery can provide electrical energy to a variety of electrical devices. The hybrid rectifier 200 is configured to receive an alternating current (AC) from an AC source, such as a utility grid 102, and provide a voltage across a dynamically varying direct current (DC) load matching a desired target DC reference value. The output of the hybrid rectifier 200 is provided to a power regulator 106 that generates a fixed output voltage of a preset magnitude to prevent overcharging and damaging the energy storage device 108. Although not shown, it will be acknowledged by persons skilled in the art that the hybrid rectifier 200 may also be employed in AC/DC power transmission line network, double conversion uninterrupted power supply (UPS), or any other type of electronic circuit connected to a utility grid for providing a desired DC voltage, as described in detail in the forthcoming disclosure.

FIG. 2 illustrates a circuit diagram of the hybrid rectifier 200. In accordance with various embodiments, the hybrid rectifier 200 is configured to drive a dynamically varying direct current (DC) load (V_{dc}). The hybrid rectifier 200 includes a first unit 202 having at least two transformers (T₁, T₂, . . . T_{N}). The transformers (T₁, T₂, . . . T_{N}) are configured to receive a three-phase input of the alternating current (AC) from the AC source, such as the utility grid 102, having a supply voltage (V₁) and operably provide at least two AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ). For example, the transformer (T₁) is configured to receive the three-phase input of the alternating current (AC) and operably provide the AC output (I₁) such that the voltage (V_{PS1}) associated with the corresponding AC output (I₁) is phase shifted from the supply voltage (V₁). The transformer (T₂) is configured to receive the three-phase input of the alternating current (AC) and operably provide the AC output (I₂) such that the voltage (V_{PS2}) associated with the corresponding AC output (I₂) is phase shifted from the supply voltage (V₁).

Each transformer (T₁, T₂, . . . T_{N}) is a phase-shift transformer having three primary windings and three secondary windings. The primary windings and the secondary windings may be arranged in a variety of configurations, for example, a star-star (Y-Y) configuration, a star-delta (Y-D) configuration, or a star-interconnected star (Y-Z) configuration, depending upon the phase shift required between the three-phase input of the alternating current (AC) and the corresponding AC output (I₁, I₂, . . . I_{N}). The three primary windings of each transformer (T₁, T₂, . . . T_{N}) are configured to receive respective phases of the three-phase input of the AC signal having the supply voltage (V₁) from the AC source. The three secondary windings of each transformer (T₁, T₂, . . . T_{N}) are configured to operably provide the corresponding AC output (I₁, I₂, . . . I_{N}) having corresponding voltage (V_{PS1}, V_{PS2} . . . V_{PSN}) that is phase shifted from the supply voltage (V₁) successively by the predetermined angle (θ). For example, the three secondary windings of the transformer (T₁) are configured to operably provide the AC output (I₁) having voltage (V_{PS1}) that is phase shifted from the supply voltage (V₁) by the predetermined angle (θ), the three secondary windings of the transformer (T₂) are configured to operably provide the AC output (I₂) having voltage (V_{PS2}) that is phase shifted from the supply voltage (V₁) by the predetermined angle (θ), and so on. Although not shown, in an alternate embodiment, the first unit 202 may include a single transformer having a set of three primary windings configured to receive respective phases of the three-phase input of the AC signal having the supply voltage (V₁) from the AC source and at least two sets of three secondary windings to operably provide the at least two AC outputs (I₁, I₂, . . . I_{N}) that are phase shifted with respect to one another.

The predetermined angle (θ) may be determined based on a number of AC outputs (I₁, I₂, . . . I_{N}) provided by the transformers (T₁, T₂, . . . T_{N}). For example, the predetermined angle (θ) may be equal to 60±5/N, where N corresponds to a number of AC outputs (I₁, I₂, . . . I_{N}) provided by the transformers (T₁, T₂, . . . T_{N}). For example, when the number of AC outputs (I₁, I₂, . . . I_{N}) provided by the transformers (T₁, T₂, . . . T_{N}) are three (3), the predetermined angle (θ) is approximately equal to 20 degrees (i.e., 60/3). For such a hybrid rectifier 200′, as shown in FIG. 4, the AC output (I₁) of the transformer (T₁) is phase shifted from the first voltage (V₁) by 20 degrees and the AC output (I₃) of the transformer (T₃) is phase shifted from the first voltage (V₁) by minus (−) 20 degrees. Similarly, when the number of AC outputs (I₁, I₂, . . . I_{N}) provided by the transformers (T₁, T₂, . . . T_{N}) are four (4), the predetermined angle (θ) is approximately equal to 15 degrees (i.e., 60/4). For such a hybrid rectifier 200″, as shown in FIG. 5, the AC output (I₁) of the transformer (T₁) and the AC output (I₃) of the transformer (T₃) are phase-shifted from the first voltage (V₁) by 15 degrees. Furthermore, the AC output (I₄) of the transformer (T₄) is phase-shifted from the first voltage (V₁) by minus (−) 30 degrees. In accordance with various embodiments, a maximum difference between phases of the transformers (T₁, T₂, . . . T_{N}) lies within a range of 60±5 degrees.

The first unit 202 further includes at least two passive rectifiers (R_{P1}, R_{P2}, . . . R_{PN}) corresponding to, and connected in series with, the transformers (T₁, T₂, . . . T_{N}). The passive rectifiers (R_{P1}, R_{P2}, . . . R_{PN}) are configured to receive corresponding ones of the phase shifted AC outputs (I₁, I₂, . . . I_{N}) from the transformers (T₁, T₂, . . . T_{N}) as input and provide corresponding DC outputs having voltages (V_{PR1}, V_{PR2} . . . V_{PRN}). For example, the passive rectifier (R_{P1}) is configured to receive the phase shifted AC output (I₁) from the transformer (T₁) as input and provide corresponding DC output having voltage (V_{PR1}), the passive rectifier (R_{P2}) is configured to receive the phase shifted AC output (I₂) from the transformer (T₂) as input and provide corresponding DC output having voltage (V_{PR2}), and so on.

Each passive rectifier (R_{P1}, R_{P2}, . . . R_{PN}) is three-phase rectifier including one or more diodes (D₁, D₂, D₃, D₄, D₅, D₆). In some embodiments, the passive rectifier (R_{P1}, R_{P2}, . . . R_{PN}) may be a half bridge rectifier, a full bridge rectifier (as shown in FIG. 2) or any configuration of the diodes (D₁, D₂, D₃, D₄, D₅, D₆), configured to convert an AC signal, such as the phase shifted AC output (I₁, I₂, . . . I_{N}) to the corresponding DC output. As shown in FIG. 2, each passive rectifier (R_{P1}, R_{P2}, . . . R_{PN}) receives the corresponding phase-shifted AC output (I₁, I₂, . . . I_{N}) from the three secondary windings of the corresponding transformer (T₁, T₂, . . . T_{N}). The diodes (D₁, D₂, D₃, D₄, D₅, D₆) in each passive rectifier (R_{P1}, R_{P2}, . . . R_{PN}) are configured to allow the corresponding AC output (I₁, I₂, . . . I_{N}) to flow in only one direction, thereby converting the corresponding AC output (I₁, I₂, . . . I_{N}) to a DC output having voltage (V_{PR1}, V_{PR2} . . . V_{PRN}).

The hybrid rectifier 200 further includes a second unit 204 arranged in parallel to the first unit 202 on the input side corresponding to the AC source having the supply voltage (V₁). The second unit 204 has a transformer (T_{A}) configured to receive the three-phase AC input having the supply voltage (V₁) and provide an AC output (I_{A}) having a voltage (V_{AO}). The transformer (T_{A}) is a phase-shift transformer having three primary windings and three secondary windings. The three primary windings are configured to receive respective phases of the three-phase input of the AC signal from the AC source. The three secondary windings of the transformer (T_{A}) are configured to operably provide the AC output (I_{A}) having voltage (V_{AO}). The primary windings and the secondary windings of the transformer (T_{A}) may be arranged in any configuration, for example, a star-star (Y-Y) configuration, a star-delta (Y-D) configuration, or a star-zigzag (Y-Z) configuration.

The second unit 204 further includes an active rectifier (R_{A}) connected in series with the transformer (T_{A}). The active rectifier (R_{A}) is configured to receive the AC output (I_{A}) from the transformer (T_{A}) as input and provide a DC output having a dynamically varying control voltage (V_{ARC}). The active rectifier (R_{A}) is a three-phase rectifier including one or more fully controllable semiconductor devices (Q₁, Q₂, Q₃, Q₄, Q₅, Q₆). The fully controllable semiconductor device (Q₁, Q₂, Q₃, Q₄, Q₅, Q₆) includes one of: an Insulated-Gate Bipolar Transistor (IGBT), Metal Oxide semiconductor field effect transistor (MOSFET) and a Junction field effect transistor (JFET). The fully controllable semiconductor devices (Q₁, Q₂, Q₃, Q₄, Q₅, Q₆) in the active rectifier (R_{A}) are configured to control the flow of the AC output (I_{A}), thereby converting the AC output (I_{A}) to the DC output having the dynamically varying control voltage (V_{ARC}).

In accordance with various embodiments, the output sides of the first unit 202 and the second unit 204 are serially connected such that the total voltage (V_{T}) obtained across the dynamically varying DC load (V_{dc}) is a sum of the DC outputs of the first unit 202 and the second unit 204, as indicated below:

V_{T}=V_{PR1}+V_{PR2}+ . . . V_{PRN}+V_{ARC}

In order to obtain the total voltage (V_{T}) across the dynamically varying DC load (V_{dc}) corresponding to a desired target DC reference value (V_{ref}), the hybrid rectifier 200 further includes a control system 206 coupled to the active rectifier (R_{A}) of the second unit 204. The control system 206 is configured to measure the total voltage (V_{T}=V_{PR1}+V_{PR2}+ . . . V_{PRN}+V_{ARC}), from the DC outputs of the first unit 202 and the second unit 204, across the dynamically varying DC load (V_{dc}) and receive the desired target DC reference value (V_{ref}) from a user as input. The control system 206 is further configured to determine an error (E) between the total voltage (V_{T}) across the dynamically varying DC load (V_{dc}) and the desired target DC reference value (V_{ref}) input by the user. Based on the determined error (E), the control system 206 is configured to vary the control voltage (V_{ARC}) of the DC output by the active rectifier (R_{A}) to facilitate the matching of the total voltage (V_{T}) across the dynamically varying DC load (V_{dc}) with the desired target DC reference value (V_{ref}) input by the user in driving the load. In some embodiments, the control system 206 is configured to vary the control voltage (V_{ARC}) of the DC output by the active rectifier (R_{A}) if a voltage of the three-phase input of alternating current (AC) from the AC source deviates from the supply voltage (V₁) rated for the given AC source. The detailed operation of the control system 206 will be described in greater detail with respect to FIG. 3 in the forthcoming disclosure.

FIG. 3 illustrates a circuit diagram of the control system 206 coupled to the active rectifier (R_{A}) of the hybrid rectifier 200, in accordance with various embodiments. The control system 206 includes a Proportional-Integral (PI) controller (PI₁). The PI controller (PI₁) uses control parameters, such as, a proportional term and an integral term to adjust a direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit 202 until the total voltage (V_{T}) across the dynamically varying DC load (V_{dc}) is equal to the desired target DC reference value (V_{ref}).

The PI controller (PI₁) is configured to receive the determined error (E) to adjust the park-transformed direct component of current (I_{d}) input to the active rectifier (R_{A}) by the transformer (T_{A}) of the second unit 204. The PI controller (PI₁) is configured to generate a control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and the sum of voltages (V_{PR1}+V_{PR2}+ . . . V_{PRN}) corresponding to the DC outputs from the passive rectifiers (R_{P1}, R_{P2}, . . . R_{PN}) of the first unit 202 until the total voltage (V_{T}) across the dynamically varying DC load (V_{dc}) is equal to the desired target DC reference value (V_{ref}).

To this end, the control system 206 further includes a park transform block 208 to obtain the park-transformed direct component (I_{d}) and a park-transformed quadrature component (I_{q}) of the measured current (I_{A}), via park transformation. The park transform block 208 receives the measured current (I_{A}) provided by the transformer (T_{A}) and converts the components of the measured current (I_{A}) in a stationary reference frame to generate the direct component (I_{d}) and the quadrature component (I_{q}) of the current (I_{A}) in a rotating reference frame according to a rotational angle. The rotational angle represents an angular position of the rotating reference frame with respect to the stationary reference frame. A d-axis current controller 210 receives the direct component (I_{d}) of the measured current (I_{A}) from the park transform block 208 and the control current reference (I_{dref}) from the PI controller (PI₁), processes the received signals so that the deviation between the direct component (I_{d}) and the control current reference (I_{dref}) becomes zero, and generates a control direct voltage (Va).

The control system 206 further includes a q-axis current controller 212 that receives the quadrature component (I_{q}) of the measured current (I_{A}) from the park transform block 208 and generates a control quadrature voltage (V_{q}). An inverse park transformation is then performed on the control direct voltage (V_{d}) and the control quadrature voltage (V_{q}), by an inverse park transform block 214, to transform the control direct voltage (V_{d}) and the control quadrature voltage (V_{q}) in the rotating reference frame into a three-phase control voltage in the stationary reference frame. The three-phase control voltage is provided as input to a pulse width modulation (PWM) block 216 that generates control signals for controlling the fully controllable semiconductor devices (Q₁, Q₂, Q₃, Q₄, Q₅, Q₆) in the active rectifier (R_{A}) to enable the active rectifier (R_{A}) to generate the DC output with the dynamically varying control voltage (V_{ARC}) such that the control voltage (V_{ARC}) is equal to the difference between the desired target DC reference value (V_{ref}) and the sum of voltages (V_{PR1}+V_{PR2}+ . . . V_{PRN}) corresponding to the DC outputs from the passive rectifiers (R_{P1}, R_{P2}, . . . R_{PN}) of the first unit 202 until the total voltage (V_{T}) across the dynamically varying DC load (V_{dc}) is equal to the desired target DC reference value (V_{ref}).

### INDUSTRIAL APPLICABILITY

The hybrid rectifier 200 of the present disclosure provides a desired level of voltage regulation while increasing the overall reliability of the hybrid rectifier 200. By varying the control voltage (V_{ARC}) of the active rectifier (R_{A}), the total voltage (V_{T}) across the dynamically varying DC load (V_{dc}) can be made equal to the desired target DC reference value (V_{ref}). Moreover, the use of multiple passive rectifiers (R_{P1}, R_{P2}, . . . R_{PN}) employing one or more diodes (D₁, D₂, D₃, D₄, D₅, D₆) increases the reliability of the hybrid rectifier 200. Additionally, the use of phase shift transformers (T₁, T₂, . . . T_{N}) eliminates the need to have large capacitors for reducing the ripples in the output DC voltage (V_{dc}).

FIG. 6 shows a variation in the pulses/ripples in the output DC voltage (V_{dc}) with the increase in the number of passive rectifiers (R_{P1}, R_{P2}, . . . R_{PN}). In accordance with various embodiments, the voltage rating of the fully controllable semiconductor device in the active rectifier (R_{A}) may be exemplarily defined as:

$$1.2 * {V}_{d c} / ( M + 1 ) \qquad Equation 1$$

wherein 1.2, can be exemplarily considered as a safety factor (which may be a predefined value depending on specific requirements of an application) for the fully controllable semiconductor device (Q₁, Q₂, Q₃, Q₄, Q₅, Q₆) and M corresponds to a number of passive rectifiers (R_{P1}, R_{P2}, . . . R_{PN}). For sake of simplicity in the present disclosure, it may be noted that although the notation “V_{dc}” has been previously used herein to reference the output DC voltage, wherever the context so applies herein and at least in equation 1 disclosed above, the notation “V_{dc}” should be considered as being representative of a maximum possible output DC voltage.

With continued reference to FIG. 6, the power rating of the active rectifier (R_{A}) is defined as:

$${P}_{d c} / ( M + 1 ) \qquad Equation 2$$

$$where M$$

corresponds to a number of passive rectifiers (R_{P1}, R_{P2}, . . . R_{PN}). The notation “P_{dc}” as used generally herein makes reference to the power associated with the output DC power. However, it should also be noted that the notation “P_{dc}”, wherever the context so applies and at least in equation 2 disclosed above, is used to represent a maximum possible DC power that can be output by the hybrid rectifier 200. It may be noted that M (i.e., the number of passive rectifiers (R_{P1}, R_{P2}, . . . R_{PN})) may correspond to N (i.e., the number of AC outputs (I₁, I₂, . . . I_{N}) provided by the transformers (T₁, T₂, . . . T_{N})), in accordance with various embodiments. As can be seen in FIGS. 6 and 7, the voltage rating and the power rating of the active rectifier (R_{A}) are reduced with the increase in the number of passive rectifiers (R_{P1}, R_{P2}, . . . R_{PN}). This reduces the voltage stress and the cost of the active rectifier (R_{A}) used in the hybrid rectifier 200.

In accordance with various embodiments, a method 800 for making the hybrid rectifier 200 for driving the dynamically varying direct current (DC) load (V_{dc}) is described in FIG. 8. At 802, the first unit 202 having the transformers (T₁, T₂, . . . T_{N}) and the passive rectifiers (R_{P1}, R_{P2}, . . . R_{PN}) corresponding to, and connected in series with, the transformers (T₁, T₂, . . . T_{N}) is provided. At 804, the second unit 204, having the transformer (T_{A}) and the active rectifier (R_{A}), arranged in parallel to the first unit 202 on the input side corresponding to the AC source is provided. At 806, a control system 206 is coupled to the active rectifier (R_{A}) of the second unit 204.

In accordance with various embodiments, a method 900 for operating the hybrid rectifier 200 for driving the dynamically varying direct current (DC) load (V_{dc}) is described in FIGS. 9A-9B. At 902, the transformers (T₁, T₂, . . . T_{N}) receive the three-phase input of alternating current (AC) from the AC source having the first voltage (V₁). At 904, the transformers (T₁, T₂, . . . T_{N}) provide the AC outputs (I₁, I₂, . . . I_{N}) such that the voltage (V_{PS1}, V_{PS2} . . . V_{PSN}) associated with corresponding AC outputs (I₁, I₂, . . . I_{N}) is phase shifted from the first voltage (V₁) successively by a predetermined angle (θ) equal to 60±5/N, where N corresponds to a number of AC outputs (I₁, I₂, . . . I_{N}) provided by the transformers (T₁, T₂, . . . T_{N}), and a maximum difference between phases of the transformers (T₁, T₂, . . . T_{N}) lies within a range of 60±5 degrees. At 906, the passive rectifiers (R_{P1}, R_{P2}, . . . R_{PN}) receive the corresponding ones of the phase shifted AC outputs (I₁, I₂, . . . I_{N}) from the transformers (T₁, T₂, . . . T_{N}) as input and provide corresponding DC outputs having voltages (V_{PR1}, V_{PR2} . . . V_{PRN}) at 908. At 910, the transformer (T_{A}) receives the three-phase AC input having the first voltage (V₁) and provides the AC output (I_{A}) having the voltage (V_{AO}) at 912. At 914, the active rectifier (R_{A}) receives the AC output (I_{A}) from the transformer (T_{A}) as input and provides the DC output having the dynamically varying control voltage (V_{ARC}) at 916. At 918, the control system 206 receives the desired target DC reference value (V_{ref}) and measures the total voltage (V_{T}=V_{PR1}+V_{PR2}+ . . . V_{PRN}+V_{ARC}) across the dynamically varying DC load (V_{dc}) at 920. At 922, the control system 206 determines an error (E) between the total voltage (V_{T}) across the dynamically varying DC load (V_{dc}) and the desired target DC reference value (V_{ref}) input by the user and based on the determined error (E), varies the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load at 924. In accordance with various embodiments, varying the control voltage (V_{ARC}) of the DC output by the active rectifier (R_{A}) includes receiving, by the Proportional-Integral (PI) controller (PI₁) of the control system 206, the determined error (E) to adjust the park-transformed direct component of current (I_{d}) input to the active rectifier (R_{A}) by the transformer (T_{A}) of the second unit 204 and generating, by the PI controller of the control system 206, the control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit 202 until the total voltage (V_{T}) across the dynamically varying DC load (V_{dc}) is equal to the desired target DC reference value (V_{ref}). The control voltage (V_{ARC}) of the DC output is varied by the active rectifier (R_{A}) if a voltage of the three-phase input of alternating current (AC) from the AC source deviates from the supply voltage (V₁) rated for the given AC source.

The hybrid rectifier 200 of the present disclosure can be applied to control voltage on a power distribution side of an electrical grid, for example, a double conversion UPS and/or a charging system such as, but not limited to, the charging system 100 as exemplary disclosed in conjunction with FIG. 1.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

1. A hybrid rectifier for driving a dynamically varying direct current (DC) load (V_{dc}), the hybrid rectifier comprising:
a first unit having:
at least two transformers (T₁, T₂, . . . T_{N}) configured to:
receive a three-phase input of alternating current (AC) from an AC source having a supply voltage (V₁), and
operably provide at least two AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ) equal to 60±5/N, wherein:
N corresponds to a number of AC outputs (I₁, I₂, . . . I_{N}) provided by the at least two transformers (T₁, T₂, . . . T_{N}), and
a maximum difference between phases of the at least two transformers (T₁, T₂, . . . T_{N}) lies within a range of 605 degrees;
at least two passive rectifiers (R_{P1}, R_{P2}, . . . R_{PN}) corresponding to, and connected in series with, the at least two transformers (T₁, T₂, . . . T_{N}) to receive corresponding ones of the at least two phase shifted AC outputs (I₁, I₂, . . . I_{N}) from the at least two transformers (T₁, T₂, . . . T_{N}) as input and provide corresponding DC outputs having voltages (V_{PR1}, V_{PR2} . . . V_{PRN});
a second unit arranged in parallel to the first unit on an input side corresponding to the AC source, the second unit having:
a transformer (T_{A}) configured to receive the three-phase AC input having the supply voltage (V₁) and provide an AC output (I_{A}) having a voltage (V_{AO});
an active rectifier (R_{A}) connected in series with the transformer (T_{A}) to receive the AC output (I_{A}) from the transformer (T_{A}) as input and provide a DC output having a dynamically varying control voltage (V_{ARC});
a control system coupled to the active rectifier (R_{A}) of the second unit, the control system configured to:
receive a desired target DC reference value (V_{ref}) from a user as input;
measure a total voltage (V_{T}=V_{PR1}+V_{PR2}+ . . . V_{PRN}+V_{ARC}), from the DC outputs of the first and second units, across the dynamically varying DC load (V_{dc});
determine an error (E) between the total voltage (V_{T}) across the dynamically varying DC load (V_{dc}) and the desired target DC reference value (V_{ref}) input by the user; and
based on the determined error (E), vary the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load.

2. The hybrid rectifier of claim 1, wherein output sides of the first and second units are serially connected.

3. The hybrid rectifier of claim 1, wherein each passive rectifier (R_{P1}, R_{P2}, . . . R_{PN}) of the first unit includes at least one diode (D₁, D₂, D₃, D₄, D₅, D₆).

4. The hybrid rectifier of claim 1, wherein the active rectifier (R_{A}) of the second unit includes a fully controllable semiconductor device (Q₁, Q₂, Q₃, Q₄, Q₅, Q₆).

5. The hybrid rectifier of claim 4, wherein the fully controllable semiconductor device (Q₁, Q₂, Q₃, Q₄, Q₅, Q₆) includes one of: an Insulated-Gate Bipolar Transistor (IGBT), Metal Oxide semiconductor field effect transistor (MOSFET) and a Junction field effect transistor (JFET).

6. The hybrid rectifier of claim 1, wherein the control system includes a Proportional-Integral (PI) controller (PI₁) configured to:
receive the determined error (E) to adjust a park-transformed direct component of current (I_{d}) input to the active rectifier (R_{A}) by the transformer (T_{A}) of the second unit; and
generate a control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit until the total voltage (V_{T}) across the dynamically varying DC load (V_{dc}) is equal to the desired target DC reference value (V_{ref}).

7. The hybrid rectifier of claim 1, wherein the control system is configured to vary the control voltage (V_{ARC}) of the DC output by the active rectifier (R_{A}) if a voltage of the three-phase input of alternating current (AC) from the AC source deviates from the supply voltage (V₁) rated for the given AC source.

8. A method of making a hybrid rectifier for driving a dynamically varying direct current (DC) load (V_{dc}), the method comprising:
providing a first unit having:
at least two transformers (T₁, T₂, . . . T_{N}) configured to:
receive a three-phase input of alternating current (AC) from an AC source having a supply voltage (V₁), and
operably provide at least two AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the supply voltage (V₁) successively by a predetermined angle (θ) equal to 60±5/N, wherein:
N corresponds to a number of AC outputs (I₁, I₂, . . . I_{N}) provided by the at least two transformers (T₁, T₂, . . . T_{N}), and
a maximum difference between phases of the at least two transformers (T₁, T₂, . . . T_{N}) lies within a range of 60±5 degrees;
at least two passive rectifiers (R_{P1}, R_{P2}, . . . R_{PN}) corresponding to, and connected in series with, the at least two transformers (T₁, T₂, . . . T_{N}) to receive corresponding ones of the at least two phase shifted AC outputs (I₁, I₂, . . . I_{N}) from the at least two transformers (T₁, T₂, . . . T_{N}) as input and provide corresponding DC outputs having voltages (V_{PR1}, V_{PR2} . . . V_{PRN});
providing a second unit arranged in parallel to the first unit on an input side corresponding to the AC source, the second unit having:
a transformer (T_{A}) configured to receive the three-phase AC input having the supply voltage (V₁) and provide an AC output (I_{A}) having a voltage (V_{AO});
an active rectifier (R_{A}) connected in series with the transformer (T_{A}) to receive the AC output (I_{A}) from the transformer (T_{A}) as input and provide a DC output having a dynamically varying control voltage (V_{ARC});
coupling a control system to the active rectifier (R_{A}) of the second unit, the control system configured to:
receive a desired target DC reference value (V_{ref}) from a user as input;
measure a total voltage (V_{T}=V_{PR1}+V_{PR2}+ . . . V_{PRN}+V_{ARC}), from the DC outputs of the first and second units, across the dynamically varying DC load (V_{dc});
determine an error (E) between the total voltage (V_{T}) across the dynamically varying DC load (V_{dc}) and the desired target DC reference value (V_{ref}) input by the user; and
based on the determined error (E), vary the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load.

9. The method of claim 8, further comprising serially connecting the output sides of the first and second units.

10. The method of claim 8, wherein each passive rectifier (R_{P1}, R_{P2}, . . . R_{PN}) of the first unit includes at least one diode (D₁, D₂, D₃, D₄, D₅, D₆).

11. The method of claim 8, wherein the active rectifier (R_{A}) of the second unit includes a fully controllable semiconductor device (Q₁, Q₂, Q₃, Q₄, Q₅, Q₆).

12. The method of claim 11, wherein the fully controllable semiconductor device (Q₁, Q₂, Q₃, Q₄, Q₅, Q₆) includes one of: an Insulated-Gate Bipolar Transistor (IGBT), Metal Oxide semiconductor field effect transistor (MOSFET) and a Junction field effect transistor (JFET).

13. The method of claim 8, wherein the control system includes a Proportional-Integral (PI) controller (PI₁) configured to:
receive the determined error (E) to adjust a park-transformed direct component of current (I_{d}) input to the active rectifier (R_{A}) by the transformer (T_{A}) of the second unit; and
generate a control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit until the total voltage (V_{T}) across the dynamically varying DC load (V_{dc}) is equal to the desired target DC reference value (V_{ref}).

14. The method of claim 8, wherein the control system is configured to vary the control voltage (V_{ARC}) of the DC output by the active rectifier (R_{A}) if a voltage of the three-phase input of alternating current (AC) from the AC source deviates from the supply voltage (V₁) rated for the given AC source.

15. A method of operating a hybrid rectifier for driving a dynamically varying direct current (DC) load (V_{dc}), wherein the hybrid rectifier includes first and second units parallelly connected on an input side to receive a three-phase input of alternating current (AC) from an AC source having a first voltage (V₁), the method comprising:
receiving, by at least two transformers (T₁, T₂, . . . T_{N}) in the first unit, the three-phase input of alternating current (AC) from the AC source having the first voltage (V₁),
operably providing, by the at least two transformers (T₁, T₂, . . . T_{N}), at least two AC outputs (I₁, I₂, . . . I_{N}) such that a voltage (V_{PS1}, V_{PS2} . . . V_{PSN}) associated with corresponding AC outputs (I₁, I₂, . . . I_{N}) is phase shifted from the first voltage (V₁) successively by a predetermined angle (θ) equal to 60±5/N, wherein:
N corresponds to a number of AC outputs (I₁, I₂, . . . I_{N}) provided by the at least two transformers (T₁, T₂, . . . T_{N}), and
a maximum difference between phases of the at least two transformers (T₁, T₂, . . . T_{N}) lies within a range of 60=5 degrees;
receiving, by at least two passive rectifiers (R_{P1}, R_{P2}, . . . R_{PN}) in the first unit corresponding to, and connected in series with the at least two transformers (T₁, T₂, . . . T_{N}), corresponding ones of the at least two phase shifted AC outputs (I₁, I₂, . . . I_{N}) from the at least two transformers (T₁, T₂, . . . T_{N}) as input;
providing, by the at least two passive rectifiers (R_{P1}, R_{P2}, . . . R_{PN}), corresponding DC outputs having voltages (V_{PR1}, V_{PR2} . . . V_{PRN});
receiving, by a transformer (T_{A}) in the second unit, the three-phase AC input having the first voltage (V₁);
providing, by the transformer (T_{A}), an AC output (I_{A}) having a voltage (V_{AO});
receiving, by an active rectifier (R_{A}) connected in series with the transformer (T_{A}), the AC output (I_{A}) from the transformer (T_{A}) as input;
providing, by the active rectifier (R_{A}), a DC output having a dynamically varying control voltage (V_{ARC});
receiving, by a control system coupled to the active rectifier (R_{A}) of the second unit, a desired target DC reference value (V_{ref}) from a user as input;
measuring, by the control system, a total voltage (V_{T}=V_{PR1}+V_{PR2}+ . . . V_{PRN}+V_{ARC}), from the DC outputs of the first and second units, across the dynamically varying DC load (V_{dc});
determining, by the control system, an error (E) between the total voltage (V_{T}) across the dynamically varying DC load (V_{dc}) and the desired target DC reference value (V_{ref}) input by the user; and
based on the determined error (E), varying, by the control system, the control voltage (V_{ARC}) of the DC output by the active rectifier (R_{A}) to facilitate a matching of the total voltage (V_{T}) across the dynamically varying DC load (V_{dc}) with the desired target DC reference value (V_{ref}) input by the user in driving the load,
wherein varying, by the control system, the control voltage (V_{ARC}) of the DC output by the active rectifier (R_{A}) comprises:
receiving, by a Proportional-Integral (PI) controller (PI₁) of the control system, the determined error (E) to adjust a park-transformed direct component of current (I_{d}) input to the active rectifier (R_{A}) by the transformer (T_{A}) of the second unit; and
generating, by the PI controller of the control system, a control current reference (I_{dref}) to subsequently adjust the direct component of current (I_{d}) input to the active rectifier (R_{A}) so that the active rectifier (R_{A}) generates the DC output with the dynamically varying control voltage (V_{ARC}) such that the control voltage (V_{ARC}) is equal to a difference between the desired target DC reference value (V_{ref}) and a sum of voltages (V_{PR1}+V_{PR2}+ . . . V_{PRN}) corresponding to the DC outputs from the passive rectifiers (R_{P1}, R_{P2}, . . . R_{PN}) of the first unit until the total voltage (V_{T}) across the dynamically varying DC load (V_{dc}) is equal to the desired target DC reference value (V_{ref}),
wherein the control voltage (V_{ARC}) of the DC output is varied by the active rectifier (R_{A}) if a voltage of the three-phase input of alternating current (AC) from the AC source deviates from the first voltage (V₁) rated for the given AC source.

16. The method of claim 15, wherein output sides of the first and second units are serially connected.

17. The method of claim 15, wherein each passive rectifier (R_{P1}, R_{P2}, . . . R_{PN}) of the first unit includes at least one diode (D₁, D₂, D₃, D₄, D₅, D₆).

18. The method of claim 15, wherein the active rectifier (R_{A}) of the second unit includes a fully controllable semiconductor device (Q₁, Q₂, Q₃, Q₄, Q₅, Q₆).

19. The method of claim 18, wherein the fully controllable semiconductor device (Q₁, Q₂, Q₃, Q₄, Q₅, Q₆) includes one of: an Insulated-Gate Bipolar Transistor (IGBT), Metal Oxide semiconductor field effect transistor (MOSFET) and a Junction field effect transistor (JFET).
